(19) United States
(12) Patent Application Publication
(10) Pub. No.: US 2010/0188696 A1
(43) Pub. Date: Jul. 29, 2010

(54) PRINTING SYSTEM AND PRINTING APPARATUS

(75) Inventor: Takashi OHMIYA, Nagoya-shi (JP)

Correspondence Address: Scully, Scott, Murphy & Presser, P.C., 400 Garden City Plaza, Suite 300, Garden City, NY, 11530, US

(73) Assignee: BROTHER KOGYO KABUSHIKI KAISHA, Aichi-ken (JP)

(21) Appl. No.: 12/691,214

(22) Filed: Jan. 21, 2010

(30) Foreign Application Priority Data
Jan. 23, 2009 (JP) 2009-012553

(51) Int. Cl. G06F 15/00; G08B 13/14

(52) U.S. Cl. 358/1.15; 340/572.1

(57) ABSTRACT

A printing system and a printing apparatus are provided. The printing system includes, a printing unit configured to print image data on a printing sheet, a detecting unit configured to detect an error which prevents the printing unit from printing the image data without preventing a printing sheet from being transported, a writing unit configured to write reference information to a printing sheet based on the detection of the error by the detecting unit, the reference information including at least one of the image data and information for obtaining the image data from a storage location of the image data, and a control unit configured to perform a control of reading the reference information written by the writing unit, obtaining the image data based on the read reference information and printing the obtained image data on a printing sheet by the printing unit.

### CROSS-REFERENCE TO RELATED APPLICATIONS

This application claims priority from Japanese Patent Application No. 2009-012553, filed on Jan. 23, 2009, the entire subject matter of which is incorporated herein by reference.

### TECHNICAL FIELD

Aspects of the present invention relates to a printing system and a printing apparatus which prints image data on a printing sheet.

### BACKGROUND

In a printing apparatus such as a printer, a part of image data is lost due to an incomplete printing process caused by lack of color agent or the like. Accordingly, a related-art printer performs a printing process when it is determined that the remaining amount of color agent is sufficient, and stores image data of a printing object on a hard disk when it is determined that the remaining amount is below a threshold value.

### SUMMARY

However, in the related-art printing apparatus, when the image data is stored on the hard disk of the printing apparatus due to an incomplete printing process, not only the user controlling the printing process but also any user who is allowed to use the printing apparatus can easily print the image data stored the hard disk. Therefore, security is not sufficient.

Accordingly, it is an aspect of the present invention to provide a printing system and a printing apparatus which can securely store the image data when the printing process is not completely performed.

According to an exemplary embodiment of the present invention, there is provided a printing system comprising: a printing unit configured to print image data on a printing sheet; a detecting unit configured to detect an error which prevents the printing unit from printing the image data without preventing a printing sheet from being transported; a writing unit configured to write reference information to a printing sheet based on the detection of the error by the detecting unit, the reference information including at least one of the image data and information for obtaining the image data from a storage location of the image data; and a control unit configured to perform control of reading the reference information written by the writing unit, obtaining the image data based on the read reference information and printing the obtained image data on a printing sheet by the printing unit.

According to another exemplary embodiment of the present invention, there is provided a printing apparatus comprising: a printing unit configured to print image data on a printing sheet; a detecting unit configured to detect an error which prevents the printing unit from printing the image data without preventing a printing sheet from being transported; and a writing unit configured to write reference information to a printing sheet based on the detection of the error by the detecting unit, the reference information including at least one of the image data and information for obtaining the image data from a storage location of the image data.

According to a further exemplary embodiment of the present invention, there is provided a printing system comprising: a sheet transporting unit configured to transport a printing sheet; a printing unit configured to print image data on the printing sheet transported by the sheet transporting unit; a detecting unit configured to detect an error occurring in the printing unit; a data writing unit configured to write reference information to a printing sheet based on the detection of the error by the detecting unit, the reference information including at least one of the image data and identification information for identifying a storage location of the image data; a data reading unit configured to read reference information written in a printing sheet to obtain image data based on the reference information; and a print controller configured to control the printing unit to print the image data obtained based on the reference information on a printing sheet.

According to the above configuration, it is possible to realize the printing system and the printing apparatus which can securely store the image data when the printing process is not completely performed.

### BRIEF DESCRIPTION OF THE DRAWINGS

The above and other aspects of the present invention will become more apparent and more readily appreciated from the following description of exemplary embodiments of the present invention taken in conjunction with the attached drawings, in which:

FIG. 1 is a perspective view showing a schematic configuration of a MFP according to exemplary embodiments of the present invention;

FIG. 2 is a conceptual diagram showing a schematic configuration of an image forming unit of the MFP;

FIG. 3 is a block diagram showing an electric configuration of the MFP;

FIG. 4 is a diagram showing an example of a setting screen for setting an image data storage location when an incomplete printing error occurs;

FIG. 5 is a diagram showing an example of a setting screen for setting an operation mode when discharging a printing sheet;

FIG. 6 is a flowchart showing a sequence of a printing process according to a first exemplary embodiment of the present invention;

FIG. 7 is a flowchart showing a sequence of a printing process according to a second exemplary embodiment of the present invention;

FIG. 8 is a flowchart showing a sequence of a writing process according to the second exemplary embodiment of the present invention; and

FIG. 9 is a flowchart showing a sequence of a reading printing process according to exemplary embodiments of the present invention.

### DETAILED DESCRIPTION

Hereinafter, a printing apparatus according to exemplary embodiments of the present invention will be described in detail with reference to the accompanying drawings. In these exemplary embodiments, a Multi Function Peripheral (MFP) which is capable of accessing a Radio Frequency Identification (RFID) tag is described as a printing apparatus.

[Overall Configuration of MFP]

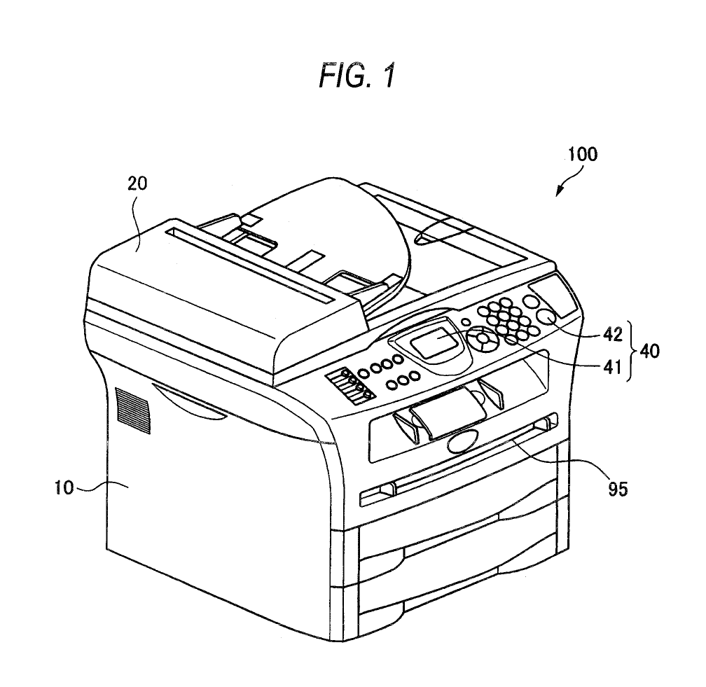

As shown in FIG. 1, an MFP 100 according to exemplary embodiments of the present invention includes an image forming unit 10 which prints an image on a printing sheet, and an image reading unit 20 which reads an image on a document. Additionally, a manual insertion opening 95 is provided in a front surface of the image forming unit 10. The printing sheet is manually inserted through the manual insertion opening 95 to be fed. Further, an operation panel 40 is provided in the front surface of the image reading unit 20. The operation panel 40 includes a display portion 41 having a liquid crystal display and a button group 42 including a start key, a stop key, a numeral key, and the like. Through the operation panel 40, the operation state is displayed and a user's input operation is performed.

[Configuration of Image Forming Unit]

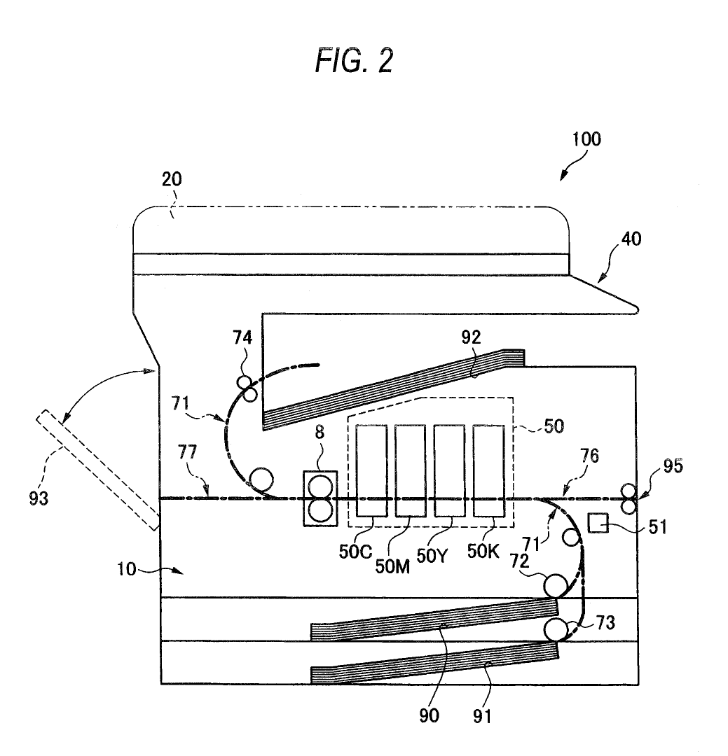

The image forming unit 10 forms an image by an electrophotographic method. As shown in FIG. 2, the image forming unit 10 includes a process section 50 which forms a toner image and transfers the toner image onto a printing sheet, a fixing section 8 which fixes an unfixed toner image onto the printing sheet, first and second sheet feeding cassettes 90 and 91, in which printing sheets are stored before an image being formed thereon, and a sheet discharging tray 92 on which printing sheets are discharged after an image being formed thereon.

The image forming unit 10 includes a substantially S-shaped transport path 71 therein which guides a printing sheet stored in the sheet feeding cassette 90 or 91 provided at the bottom portion of the image forming unit 10 to the sheet discharging tray 92 provided at the upper portion thereof through a sheet feeding roller 72 or 73, the process section 50, the fixing section 8, and a sheet discharging roller 74. That is, the image forming unit 10 feeds a printing sheet stored in the sheet feeding cassette 90 or 91 one-by-one, transports the printing sheet to the process section 50, and then transfers the toner image formed by the process section 50 onto the printing sheet. Subsequently, the image forming unit 10 transports the printing sheet having the toner image transferred thereon to the fixing section 8 so as to heat-fix the toner image onto the printing sheet. Then, the image forming unit 10 discharges the printing sheet having the toner image fixed thereto to the sheet discharging tray 92. A transporting unit is configured by components for transporting the printing sheets, such as the transport path 71, sheet feeding roller 72 or 73, the sheet discharging roller 74 and the like.

The image forming unit 10 includes a substantially linear transport path 76 which guides a printing sheet inserted through the manual insertion opening provided in the front side surface of the image forming unit 10 to the process section 50. Further, an openable cover 93 is provided in the rear side surface of the image forming unit 10. The image forming unit 10 further includes a substantially linear transport path 77 which guides the printing sheet having the toner image fixed thereon to the cover 93, so that the cover 93 is used as a sheet discharging tray when the cover is open.

The process section 50 includes image forming portions 50C, 50M, 50Y, and 50K which correspond to colors of cyan, magenta, yellow, and black, respectively, and disposed in parallel with each other along the transport path 71, so that the process section 50 forms a color image. Each of the image forming portions 50C, 50M, 50Y, and 50K is configured to form a toner image by an electrophotographic method, and includes a photosensitive member, a charger, an exposure device, a developer, a transfer member, a cleaning blade, and the like. The process section 50 forms the toner images by using the image forming portions 50C, 50M, 50Y, and 50K, and overlaps the toner images on the printing sheet transported onto the transport path 71 so as to form a color image.

Additionally, the image forming unit 10 includes a Read and Write (R/W) section 51 which detects an RFID tag existing in a predetermined range and reads and writes data from or to the RFID tag. The R/W section 51 is provided in a range capable of accessing the RFID tag when a printing sheet attached with the RFID tag (referred to as “RFID printing sheet”) is transported onto the transport path 71.

[Electric Configuration of MFP]

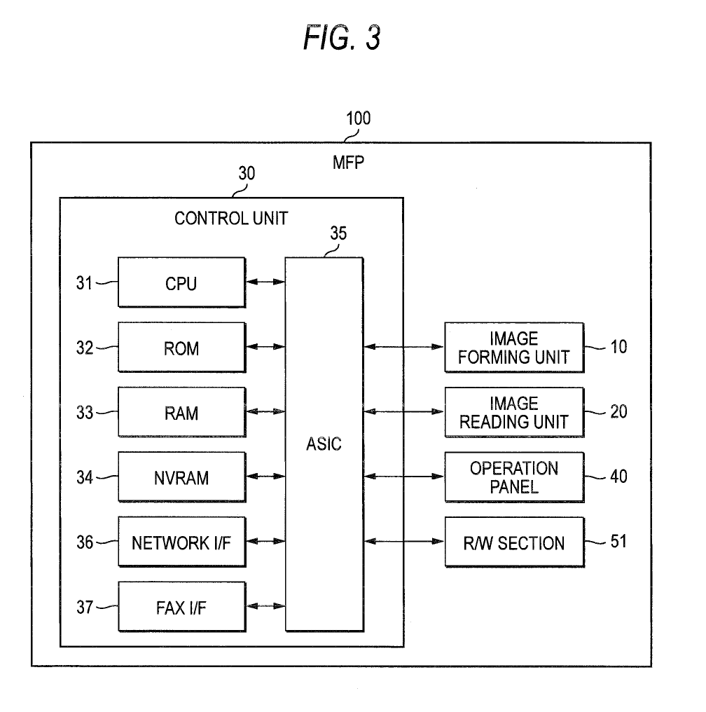

Subsequently, an electric configuration of the MFP 100 will be described. As shown in FIG. 3, the MFP 100 includes a control unit 30 which includes a Central Processing Unit (CPU) 31, a Read Only Memory (ROM) 32, a Random Access Memory (RAM) 33, a Non-Volatile RAM (NVRAM) 34, an Application Specific Integrated Circuit (ASIC) 35, a network interface 36, and a FAX interface 37.

The CPU 31 performs operations for realizing various functions such as an image reading function and an image forming function of the MFP 100. The ROM 32 stores various control programs, various settings, initial values, and the like for controlling the MFP 100. The RAM 33 is used as an operation region from which various control programs are read or a storage region in which image data is temporarily stored. The NVRAM 34 is used as a storage region in which image data, various setting and the like are stored.

The CPU 31 operates according to control programs read from the ROM 32 or signals sent from various sensors, and stores the operation result in the RAM 33 or the NVRAM 34 so as to control respective components of MFP 100 (for example, a timing of turning on the exposure member of the image forming unit 10, a driving motor (not shown) of various rollers of the printing sheet transport path, and a motor (not shown) moving an image sensor unit of the image reading unit 20) through the ASIC 35.

The network interface 36 is connected to a network such as an internet so as to be connected to an image processing apparatus such as a PC. The FAX interface 37 is connected to a telephone line so as to be connected to a FAX apparatus of a destination. The CPU 31 is capable of exchanging a job via the network interface 36 or the FAX interface 37.

[Printing Process]

### First Exemplary Embodiment

A printing process performed by the MFP 100 will be described. The MFP 100 has a backup function of storing image data to be printed in the RFID tag or a designated storage location when the MFP 100 is in an incomplete printing state. Herein, the incomplete printing state indicates a state in which a printing sheet is not prevented from being transported, but the printing process is prevented from being performed. In other words, the incomplete printing state indicates a state having an error which does not prevent the transporting unit from transporting the printing sheet, but prevents the image forming unit 10 from performing printing process. This incomplete printing state includes a state in which the printing process is possible to be performed, but a part of the image data is omitted due to a reason such as an insufficient toner amount. In the following description, the backup function will be described.

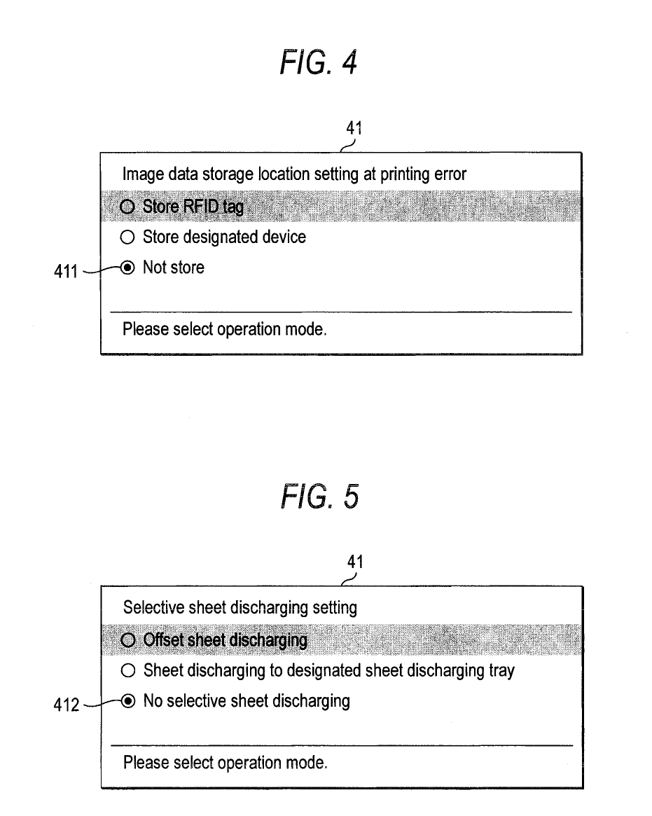

The MFP 100 has several operation modes for realizing the backup function. Accordingly, one operation mode to be operated is set in the MFP 100. In the first exemplary embodiment, the setting screen shown in FIG. 4 is displayed on the display portion 41 of the operation panel 40 so as to prompt a user to select one operation mode. When the user selects one of the operation modes by using a radio button 411, the operation mode is selected.

Specifically, in the first exemplary embodiment, the next three operation modes can be selected. The first operation mode is an operation mode (referred to as “storage mode A”) in which image data to be printed is stored (written) in an RFID tag. The RFID tag is attached to the printing sheet to be provided in the form of the RFID printing sheet. The second operation mode is an operation mode (referred to as “storage mode B”) in which the image data to be printed is stored in another device, and information (for example, an IP address or directory information) used as a reference for obtaining the image data from a storage location is stored (written) in the RFID tag. In this case, the other device to be used as the storage location of the image data has been set as a designated device in advance. Herein, information stored in the RFID tag by using the storage mode A or the storage mode B is referred to as “reference information”. The third operation mode is an operation mode in which the image data is not stored anywhere.

The MFP 100 has a selective sheet discharging function. In the sheet discharging function, the RFID printing sheet having reference information stored thereon, and a printing sheet not having reference information stored thereon in a printing process (referred to as “normal printing process”) can be sorted and discharged when the storage mode A or the storage mode B is selected, that is, the RFID printing sheet is selected to be used. In the first exemplary embodiment, the setting screen shown in FIG. 5 is displayed on the display portion 41 of the operation panel 40 so as to prompt the user to select one operation mode. When the user selects one of operation modes by using the radio button 412, the operation mode is selected.

Specifically, in this first exemplary embodiment, the following three operation modes can be selected. The first operation mode is an operation mode (referred to as “sheet discharging mode A”) in which the sheet discharging tray set for a print job, in which printing is stopped, is caused to perform an offset sheet discharging process. The offset sheet discharging process indicates a sheet discharging mode in which a printing sheet is discharged to a position slightly offset from a printing sheet discharged during the normal printing process on the same sheet discharging tray used to perform the normal printing process. The second operation mode is an operation mode (referred to as “sheet discharging mode B”) in which the printing sheet is discharged to the sheet discharging tray set for performing a selective sheet discharging process. The third operation mode is an operation mode (referred to as “normal sheet discharging mode”) in which the selective sheet discharging process is not performed. When a mechanism (for example, a sliding mechanism of the sheet discharging tray) used to realize the offset sheet discharging process is not provided, the selection of the sheet discharging mode A may be limited by gray out or non-display. Further, when a plurality of sheet discharging trays are not provided, the selection of the sheet discharging mode B may be limited similarly.

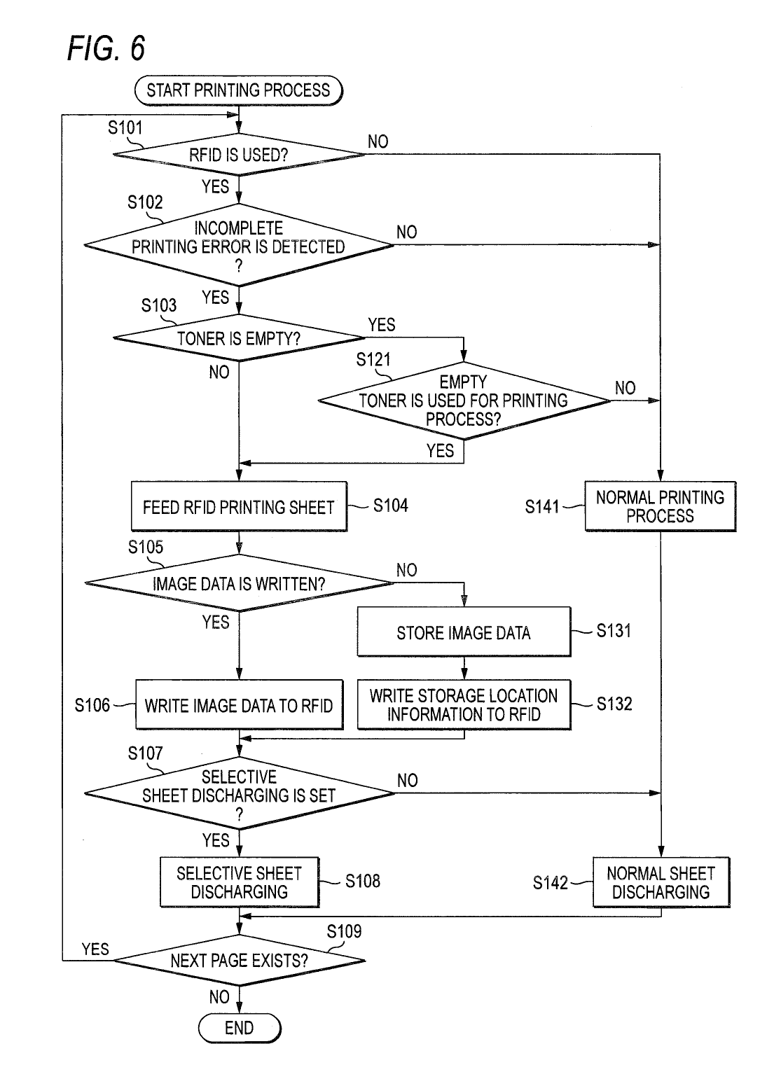

Hereinafter, an operation of a printing process, particularly, an operation of the backup function will be described with reference to the flowchart in FIG. 6. This process starts upon receiving a print job.

First, it is determined whether it is set that the RFID tag is used when an incomplete printing error occurs (S101). That is, it is determined whether the storage mode A or the storage mode B is selected as the operation mode of the backup function. When the RFID tag is not used (NO in S101), the normal printing process is performed (S141), and the normal sheet discharging process is performed (S142).

When the RFID tag is used (YES in S101), it is determined whether occurrence of an incomplete printing error is detected (S102). Examples of incomplete printing error may include, for example, an empty toner, insufficient fixing temperature, an operation error (a scanner trouble or the like) of the image reading unit 20, and an operation error (an error of the exposure member or the like) of the process section 50. In the cases of these examples, the printing sheet is not prevented from being transported, but the printing process is prevented from being performed. Herein, for example, whether the empty toner exists is determined whether a remaining toner amount is less than a threshold value or whether the remaining toner amount is less than a value required in the printing process. When the incomplete printing error does not occur (NO in S102), the normal printing process is performed (S141), and the normal sheet discharging process is performed (S142).

The incomplete printing error does not include an error occurring when the printing sheet is prevented from being transported due to an erroneous operation of a sheet transporting roller. Accordingly, when the printing sheet is prevented from being transported, it is determined that the “incomplete printing error” does not occur (NO in S102), and an error process involved in the normal printing process is performed.

When the incomplete printing error is detected (YES in S102), it is determined whether the error is caused by an empty toner (S103). When the error is caused by the empty toner (YES in S103), it is determined whether the empty toner is used in the printing process (S121). For example, when the printing process is performed by using black toner in a monochrome printing mode, the toners of other colors are not used. That is, even if the toners of the other colors are empty, the printing process can be performed. Thus, when the empty toner is not used in the printing process (NO in S121), the normal printing process is performed (S141), and the normal sheet discharging process is performed (S142). Accordingly, unnecessary backup processes are not performed. Additionally, it is possible to prevent the error from being frequently detected, and it is possible to improve the reliability of the MFP 100.

When the incomplete printing error is caused not by the empty toner (NO in S103) or the toner used in printing process is empty (YES in S121), the RFID printing sheet starts to be fed (S104). In the MFP 100, the RFID printing sheet starts to be fed from a predetermined sheet feeding cassette. That is, the printing sheets (referred to as “normal printing sheets”) without an RFID tag and the RFID printing sheets are stored in separate sheet feeding cassettes. Therefore, the RFID printing sheets can be fed automatically. In this process, the RFID printing sheet is used only when the incomplete printing error occurs, and the RFID printing sheet is not always used. Generally, the RFID printing sheet is more expensive compared with the printing sheet without the RFID tag. Therefore, by using the RFID printing sheet only when the incomplete printing error occurs, it is possible to reduce the frequency of using the expensive RFID printing sheet.

When only one sheet feeding section is provided or a function of selecting the sheet feeding section when an incomplete printing error occurs is not provided, for example, an instruction message to set the RFID printing sheets may be displayed on the display portion 41. Then, when a user presses the start key after the user sets the RFID printing sheets, an operation of transporting the RFID printing sheets can be started.

Subsequently, it is determined whether the reference information written to the RFID tag is the image data, that is, the storage mode A is set (S105). When the reference information is the image data (YES in S105), the image data to be printed is written to the RFID tag (S106). On the other hand, when the reference information is not the image data, that is, the storage mode B is set (NO in S105), the image data to be printed and identification information of the RFID tag are stored in a designated device (S131). Additionally, the reference information for obtaining the image data from the designated device is written to the RFID tag (S132). After the reference information is written to the RFID tag in S106 or S132, the image data is deleted from the memory. That is, the MFP 100 does not store the image data.

Subsequently, it is determined whether the selective sheet discharging mode is set (S107). That is, it is determined whether the sheet discharging mode A or the sheet discharging mode B is selected as the operation mode of the selective sheet discharging function. When the selective sheet discharging mode is not set (NO in S107), the RFID printing sheet having the reference information written thereto is discharged by the normal sheet discharging process (S142). On the other hand, when the selective sheet discharging mode is set (YES in S107), the RFID printing sheet having the reference information written thereto is selectively discharged in accordance with the content of the selective sheet discharging setting condition (S108). Accordingly, when the RFID printing sheet is selectively discharged, it is possible to easily distinguish printing sheets having the reference information written thereto.

After the printing sheet is discharged, it is determined whether a next page exists (S109). When a next page exists (YES in S109), the process returns to S101 so as to repeat the printing process or the backup process. On the other hand, when no next page exists (NO in S109), the process ends.

### Second Exemplary Embodiment

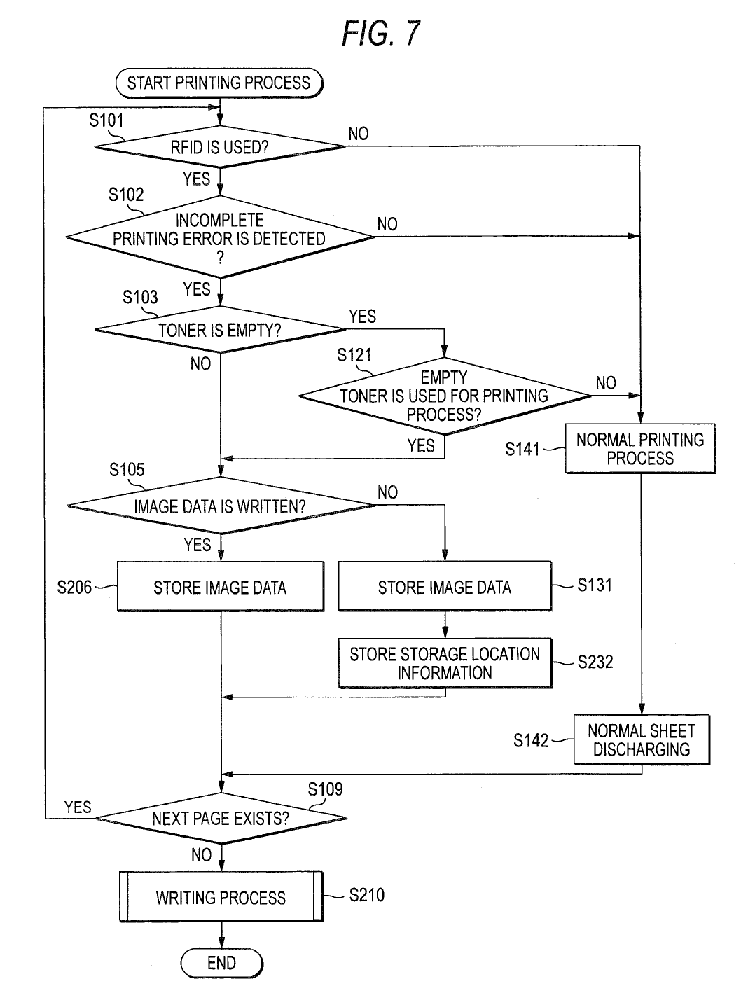

Subsequently, a printing process according to a second exemplary embodiment will be described with reference to the flowchart in FIG. 7. In the printing process according to this exemplary embodiment, the reference information of a plurality of pages is collectively written to one RFID tag. This is different from the first exemplary embodiment in which the reference information of one page is written to one RFID tag. The following description, the same reference numerals as those of the first exemplary embodiment will be given to the same processes as those of the first exemplary embodiment. Since the processes before S103, and the processes in S141 and S142 after the processes of NO in S101, NO in S102, and NO in S121 are similar to those of the first exemplary embodiment, the description thereof will be omitted.

When the incomplete printing error is not caused by the empty toner (NO in S103) or the toner used in the printing process is empty (YES in S121), it is determined whether the reference information written to the RFID tag is the image data, without feeding the RFID printing sheet (S105). When the reference information is the image data (YES in S105), the image data to be printed is stored as the data written to the RFID tag in the MFP 100 (S206). That is, the image data is stored in a region which is provided in the NVRAM 34 or the RAM 33 so as to store the data to be written to the RFID tag.

On the other hand, when the reference information is not the image data, that is, the storage mode B is set (NO in S105), the identification information of the RFID tag and the image data to be printed are stored in a designated device (S131). The reference information for obtaining the image data from the designated device is stored as the data written to the RFID tag in the MFP 100 (S232). That is, the reference information is temporarily stored in the MFP 100. Then, the normal printing process or the reference information storing process is repeated until the last page (YES in S109).

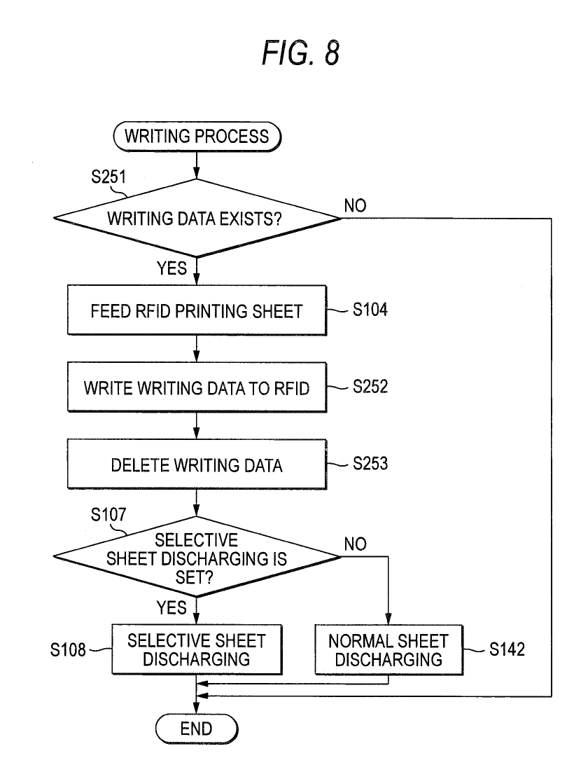

In the case of the last page (NO in S109), the temporarily stored reference information is written to the RFID tag (S210). FIG. 8 is a flowchart showing a sequence of an operation of a writing process in 5210. In the writing process, first, it is determined whether the data written to the RFID tag in S206 or S232 is stored, that is, the reference information is stored (S251). When the reference information is not stored (NO in S251), since the storage to the RFID tag is not necessary, the process ends without any process. On the other hand, when the reference information is stored (YES in S251), the RFID printing sheet starts to be fed (S104).

Subsequently, the writing data stored in S206 or S232, that is, the reference information of each page is collectively (simultaneously) written to the RFID tag (S252). Accordingly, the reference information of a plurality of pages is written to one RFID tag. Therefore, it is possible to manage the reference information by using one sheet of the RFID printing sheet, and it is possible to save the printing sheet used for the writing process. Subsequently, the writing data is deleted from the MFP 100 (S253). That is, the MFP 100 does not store the reference information. After S253, the writing process ends by performing the sheet discharging process after S107 similarly to the process in the first exemplary embodiment.

Accordingly, for example, when the printing process is not completely performed in a print job of a plurality of pages, the image data of all pages is collectively written. Addition, for example, when the image data is stored on the other device and the storage location is written as the reference information, each page data may be stored in a different directory, and the reference position of each page may be written.

[Reading Printing Process]

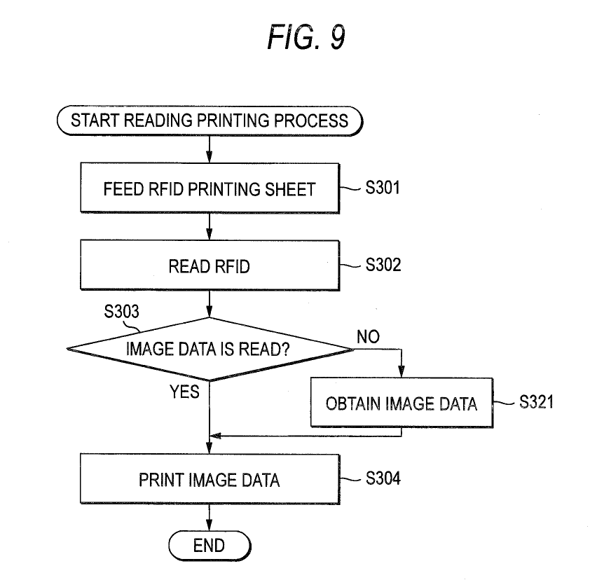

A reading printing process will be described with reference to the flowchart in FIG. 9, in which the reference information written to the RFID tag is read and the image data is obtained based on the reference information so as to be printed on the printing sheet. The reading printing process is performed by the command from the operation panel 40.

First, the RFID printing sheet starts to be fed (S301). In S301, the user may start the sheet feeding operation after commanding the setting of the RFID printing sheet, or may automatically start the sheet feeding operation on the assumption that the RFID printing sheet is set.

Subsequently, the reference information is read by the access to the RFID tag (S302). Then, it is determined whether the read reference information is the image data (S303). When the read reference information is the image data (YES in S303), the process ends by printing the read image data (S304). The image data printing process may be performed on the RFID printing sheet from which the data is read or other fed printing sheets.

On the other hand, when the read reference information is not the image data (NO in S303), the reference information for obtaining the image data from the designated device is read. Accordingly, based on the read reference information, the image data is obtained by accessing the designated device as the storage location of the image data (S321). The process ends by printing the obtained image data (S304).

As described above, when the MFP 100 detects the incomplete printing error which does not prevent the printing sheet from being transported but prevents the printing process from being completely performed, the entire image data or the reference information for obtaining the image data from a designated device is written to the RFID printing sheet. That is, even when the error is caused by lack of toner or the like, since the printing sheet is not prevented from being transported, the RFID printing sheet is transported, and the reference information is stored in the RFID printing sheet. Then, the image data is deleted from the MFP 100. At this time, a sheet transport path may be a transport path used for the printing process, or may be a transport path exclusively used for the error process. Since the reference information is written to the RFID printing sheet, and the reference information is not stored in the MFP 100, a third person cannot read the reference information from the MFP 100. Accordingly, the MFP 100 and the printing system including the MFP 100 have high security.

While the present invention has been shown and described with reference to certain exemplary embodiments thereof, it will be understood by those skilled in the art that various changes in form and details may be made therein without departing from the spirit and scope of the invention as defined by the appended claims.

For example, the present invention is not limited to the MFP, but may be applied to an apparatus having a printing function such as a printer and a copier. In addition, the image forming method of the image forming unit is not limited to the electrophotographic method, but may be an ink jet method. Further, the apparatus may forms either color images or exclusively monochrome images.

In the exemplary embodiments, two operation modes are described as the operation mode of the backup function, but it is not necessary to provide two operation modes. That is, either one of the operation modes may be provided. The storage mode A of directly storing the image data in the RFID tag has a simple configuration compared with the storage mode B, and can be performed without a network environment. Meanwhile, the storage mode B of indirectly storing the image data has a small amount of information stored in the RFID tag compared with the storage mode A, and can be performed on RFID tags having a small capacity.

In the exemplary embodiments, two operation modes are provided as the operation mode of the selective sheet discharging function, but it is not necessary to provide two operation modes. The sheet discharging mode A of performing the offset sheet discharging process can be realized in an apparatus having only one sheet discharging tray compared with the sheet discharging mode B. On the other hand, the sheet discharging mode B of selecting the sheet discharging tray does not require a particular sheet discharging mechanism used to perform the offset sheet discharging process.

In the exemplary embodiments, the operation mode of the backup function or the operation mode of the selective sheet discharging function is set through the operation panel 40 of the MFP 100, but for example, when the MFP 100 is connected to an information processing device such as a PC, the operation mode may be set through the information processing device.

In the exemplary embodiments, as the reading printing process, the MFP 100 reads the image data stored in the designated device or the RFID tag, but the image data may be read by a device other than the MFP 100. For example, the image data may be read by an exclusive reading device which can read the RFID tag.

In the exemplary embodiments, upon performing the writing process shown in FIG. 8, all reference information is written to one RFID tag, but the reference information may be written to a plurality of RFID tags. In this case, before the process in S252, it is necessary to perform a process of calculating the data amount of the writing data as the reference information of each page stored in the MFP 100, and it is necessary to perform the process in S252 after the processes in S108 and S142. That is, the data amount of the writing data is calculated before the process in S252, the writing data is stored up to the storage capacity of the RFID tag in S252, and then the RFID printing sheet is discharged. Subsequently, the same process is repeated until the writing data not stored yet is completely stored in the RFID tag. Subsequently, when the writing data is completely stored in the RFID tag, the writing data stored in the MFP 100 in S253 is deleted. According to this configuration, even in the case where the writing data cannot be stored in one RFID tag due to the large amount thereof, it is possible to store the reference information in the RFID printing sheet.

In the exemplary embodiments, as the reference information, the reference information for obtaining the image data from the designated device is written to the printing sheet, but identification information such as a password may be written as the reference information. Then, upon reading the image data, an identification process may be performed based on the identification information.

In the exemplary embodiments, in the case of writing the reference information to the printing sheet, the image data is stored in another device, but may be stored in a storage device in the MFP 100 as well as the other device. Even when a third person intends to obtain the image data stored in the MFP 100, since the printing sheet having the reference information written thereto is required to obtain the image data, the third person cannot easily obtain the image data. Accordingly, it is also possible to securely store the image data.

In the exemplary embodiments, the reference information is stored in the RFID tag, but the present invention is not limited thereto. For example, a particular image such as a QR code (trademark) or a barcode may be printed or sealed. In this case, the R/W section used to access the RFID tag is not required, and an existing unit may be used. However, in the case of printing the particular image, it is necessary to determine whether a toner amount is sufficient for printing the particular image, or it is necessary to determine whether a color printing apparatus is not prevented from being perform the printing process using other colors. Meanwhile, in the case of using the RFID tag, since the size of the RFID tag is small, it is possible to inconspicuously write the reference information to the printing sheet.

What is claimed is:

1. A printing system comprising:
a printing unit configured to print image data on a printing sheet;
a detecting unit configured to detect an error which prevents the printing unit from printing the image data without preventing a printing sheet from being transported;
a writing unit configured to write reference information to a printing sheet based on the detection of the error by the detecting unit, the reference information including at least one of the image data and information for obtaining the image data from a storage location of the image data; and
a control unit configured to perform a control of reading the reference information written by the writing unit, obtaining the image data based on the read reference information and printing the obtained image data on a printing sheet by the printing unit.

2. The printing system according to claim 1,
wherein the printing sheet on which the reference information is written includes a storage medium, and
wherein the writing unit is configured to write the reference information to the storage medium.

3. The printing system according to claim 2, further comprising:
a first sheet feeding section configured to feed a printing sheet having a storage medium; and
a second sheet feeding section configured to feed a printing sheet not having a storage medium,
wherein the printing by the printing unit is performed on the printing sheet fed from the second sheet feeding section, and
wherein the writing by the writing unit based on the detection of the error is performed on the printing sheet fed from the first sheet feeding section.

4. The printing system according to claim 1,
wherein the printing unit includes a plurality of storing portions which stores different color agents, respectively, and
wherein the detecting unit is configured to detect the error when a remaining amount of the color agent used in the printing by the printing unit becomes insufficient.

5. The printing system according to claim 1,
wherein the writing unit is configured to write a plurality of reference information for a plurality of pages to one printing sheet.

6. The printing system according to claim 1,
wherein the printing sheet having an image printed by the printing unit and the printing sheet having the reference information written by the writing unit are discharged differently.

7. A printing apparatus comprising:
a printing unit configured to print image data on a printing sheet;
a detecting unit configured to detect an error which prevents the printing unit from printing the image data without preventing a printing sheet from being transported; and
a writing unit configured to write reference information to a printing sheet based on the detection of the error by the detecting unit, the reference information including at least one of the image data and information for obtaining the image data from a storage location of the image data.

8. The printing system according to claim 2,
wherein the storage medium includes an RFID tag.

9. The printing system according to claim 1, further comprising:
a storing unit configured to store the image data in a designated storage when the information for obtaining the image data is written as the reference information.

10. The printing system according to claim 4,
wherein the detecting unit is configured to determine which color agent is used in printing the image, and configured to detect the error when a remaining amount of the color agent determined to be used is less than a threshold value.

11. The printing system according to claim 6,
wherein the printing sheet having the reference information written by the writing unit is discharged at a position offset from a position where the printing sheet having an image printed by the printing unit, on a same discharge tray.

12. The printing system according to claim 1,
wherein the information for obtaining the image data includes identification information for identifying the storage location.

13. The printing system according to claim 1, further comprising:
a setting unit configured to set which one of the image data and the information for obtaining the data is written to the printing sheet.

14. The printing system according to claim 1,
wherein the printing of the image data obtained based on the reference information is performed on the printing sheet from which the reference information is read.

15. A printing system comprising:
a sheet transporting unit configured to transport a printing sheet;
a printing unit configured to print image data on the printing sheet transported by the sheet transporting unit;
a detecting unit configured to detect an error occurring in the printing unit;
a data writing unit configured to write reference information to a printing sheet based on the detection of the error by the detecting unit, the reference information including at least one of the image data and identification information for identifying a storage location of the image data;
a data reading unit configured to read reference information written in a printing sheet to obtain image data based on the reference information; and
a print controller configured to control the printing unit to print the image data obtained based on the reference information on a printing sheet.

16. The printing system according to claim 15,
wherein the detecting unit detect a state as an error which prevents the printing unit from printing the image data and does not prevent the sheet transporting unit from transporting the printing sheet.
